(19) United States
(12) Patent Application Publication
(10) Pub. No.: US 2026/0204283 A1
(43) Pub. Date: Jul. 16, 2026

(54) FLEXURE FOR DISK DRIVE SUSPENSION

(71) Applicant: NHK SPRING CO., LTD., Yokohama-shi (JP)

(72) Inventors: Yukie YAMADA, Yokohama-shi (JP); Yuki KAWANO, Yokohama-shi (JP); Takumi KARASAWA, Yokohama-shi (JP); Takuo NODA, Yokohama-shi (JP)

(73) Assignee: NHK SPRING CO., LTD., Yokohama-shi (JP)

(21) Appl. No.: 19/445,809

(22) Filed: Jan. 12, 2026

(30) Foreign Application Priority Data
Jan. 15, 2025 (JP) 2025-005421

(51) Int. Cl. G11B 5/48

(52) U.S. Cl. CPC G11B 5/4833; G11B 5/4826

(57) ABSTRACT

A first pillow structure is provided on a first portion of a slider mounting portion. A second pillow structure is provided on a second portion of the slider mounting portion. The first pillow structure includes a low pillow portion having a first height and a high pillow portion having a second height. The high pillow portion is provided at a position closer to the second portion than the low pillow portion. A slider support surface is defined by the low pillow portion and the high pillow portion. When the flexure is viewed from a side, the slider support surface is inclined at an angle with respect to a virtual line segment along a surface of the flexure. Gaps are defined between a slider and the second pillow structure.

### CROSS-REFERENCE TO RELATED APPLICATIONS

This application is based upon and claims the benefit of priority from prior Japanese Patent Application No. 2025-005421, filed January 15, 2025, the entire contents of which are incorporated herein by reference.

### BACKGROUND OF THE INVENTION

### 1. Field of the Invention

The present invention relates to a flexure for a disk drive suspension used in an information processing apparatus such as a hard disk drive, and particularly relates to a flexure comprising a slider mounting portion.

### 2. Description of the Related Art

A hard disk drive (HDD) is sometimes used in an information processing apparatus. The hard disk drive comprises a magnetic disk rotatable about a spindle, carriage turnable about a pivot, etc. The carriage includes an arm and rotates about the pivot by a positioning motor such as a voice coil motor. In this specification, the hard disk drive may be referred to as a disk drive.

A disk drive suspension (hereinafter referred to as a “suspension”) is mounted on an arm portion of the carriage. The suspension comprises a load beam and a flexure provided along the load beam. A slider is mounted on a slider mounting portion formed near the distal end of the flexure. The slider is provided with elements (transducers) for accessing data, that is, for reading or writing data.

As described in JP 2013-149341 A (Patent Literature 1), an adhesive is sometimes used to fix the slider to the slider mounting portion in a manufacturing process of the suspension. When the slider is fixed to the slider mounting portion by the adhesive, protrusions called “pillow portions” are formed on the slider mounting portion to stabilize the posture of the slider with respect to the slider mounting portion. The adhesive is cured while the slider is supported at a predetermined position on the slider mounting portion by the pillow portions.

As a suspension that can cope with increased recording density of a disk, a suspension is known in which an actuator is provided on a gimbal portion, as in the suspension described in JP 2015-41394 A (Patent Literature 2). In one example, the actuator is formed of a piezoelectric body such as a lead zirconate titanate (PZT). The actuator moves an end portion of the slider (a part where an element for reading and writing is provided) by a minute amount in a sway direction. In this specification, "the sway direction” means the width direction of the distal end portion of the suspension.

In the suspension in which the actuator is provided on the gimbal portion, the actuator moves the slider in a sway direction. Thus, the slider mounting portion includes a first portion and a second portion. A part of the slider is fixed to the first portion by an adhesive. The other remaining portion of the slider is movable with respect to the second portion.

In the suspension described in Patent Literature 2, the adhesive supplied to the first portion of the slider mounting portion fixes the slider to the first portion in the manufacturing process. A plurality of pillow portions is provided on the slider mounting portion to stabilize the posture of the slider at the time of this bonding. These pillow portions support the slider at a predetermined position on the slider mounting portion.

The inventors of the present invention studied a moving stroke of the slider and the like in the suspension and confirmed cases in which the stroke was unstable. A possible cause is unstable contact between the pillow portions provided on the slider mounting portion and the slider. Unstable contact may adversely influence the stroke of the slider or vibration modes of the suspension which is undesirable.

One object of one embodiment of the present invention is to provide a flexure for a disk drive suspension capable of stabilizing a moving stroke of a slider mounted on a slider mounting portion.

### BRIEF SUMMARY OF THE INVENTION

According to one embodiment, a flexure for a disk drive suspension has a slider mounting portion. The slider mounting portion includes a first portion to which a part of a slider is fixed by adhesive and the like and a second portion along which the slider is movable. A connecting portion connects the first portion and the second portion to each other. A first pillow structure is provided on the first portion and has a convex shape protruding toward the part of the slider. A second pillow structure is provided on the second portion and has a convex shape protruding toward the other part of the slider.

The first pillow structure includes a low pillow portion and a high pillow portion. The low pillow portion has a first height with respect to a virtual line segment along a surface of the flexure. The high pillow portion is located closer to the second portion than the low pillow portion and has a height greater than a height of the low pillow portion. A slider support surface is defined by the low pillow portion and the high pillow portion. The slider support surface defines a gap between the slider and the second pillow structure while supporting the slider.

The flexure according to the present embodiment stabilizes movement of the slider mounted on the slider mounting portion, for example stabilizes a stroke in the sway direction.

The slider mounting portion includes, for example, a metal portion, a base insulating layer along the metal portion, an embedded portion including a conductor provided on the base insulating layer, and a cover resin layer covering the embedded portion. Preferably, the first pillow structure and the second pillow structure are provided on the cover resin layer.

Preferably, when the flexure is viewed from a side in a longitudinal direction of the suspension, the slider support surface is inclined with respect to a virtual line segment along the surface of the flexure. For example, the slider support surface is inclined in a direction in which the slider separates from the second pillow structure.

The base insulating layer may include a resin taper portion whose thickness changes from a smaller-thickness side to a larger-thickness side. In this case, the low pillow portion is provided on the smaller-thickness side, and the high pillow portion is provided on the larger-thickness side.

The base insulating layer may include a first base portion having a small thickness and a second base portion having a thickness greater than the first base portion. In this case, the low pillow portion is provided on the first base portion, and the high pillow portion is provided on the second base portion.

The metal portion may have a metal taper portion whose thickness changes from a smaller-thickness side to a larger-thickness side. In this case, the low pillow portion is provided on the smaller-thickness side of the metal taper portion, and the high pillow portion is provided on the larger-thickness side of the metal taper portion.

The metal portion may have a first metal portion having a small thickness and a second metal portion having a thickness greater than the first metal portion. In this case, the low pillow portion is provided on the first metal portion, and the high pillow portion is provided on the second metal portion.

The cover resin layer may have a first inclined portion having a small thickness formed in a part where the low pillow portion is provided and a second inclined portion having a large thickness formed in a part where the high pillow portion is provided. In this case, the slider support surface is defined by the first inclined portion and the second inclined portion.

The cover resin layer may include a first cover portion having a small thickness and a second cover portion having a thickness greater than the first cover portion. In this case, the low pillow portion is provided on the first cover portion, and the high pillow portion is provided on the second cover portion.

The low pillow portion may have a first end surface inclined along the slider support surface. The high pillow portion may have a second end surface inclined along the slider support surface. A height of the second end surface from the cover resin layer is greater than a height of the first end surface from the cover resin layer.

In the cover resin layer, the low pillow portion may have the first end surface along the surface of the flexure, and the high pillow portion may have a thickness greater than the low pillow portion and the second end surface along the surface of the flexure.

The embedded portion may have a first embedded member and a second embedded member whose thickness is greater than the first embedded member. In this case, the low pillow portion is provided on a part covering the first embedded member of the cover resin layer, and the high pillow portion is provided on a part covering the second embedded member of the cover resin layer.

An intermediate resin layer may be provided between the base insulating layer and the cover resin layer. The intermediate resin layer has a first resin portion and a second resin portion having a thickness greater than the first resin portion. In this case, the low pillow portion is preferably provided in the first resin portion, and the high pillow portion is preferably provided in the second resin portion.

An intermediate resin layer and an intermediate conductor are provided between the base insulating layer and the cover resin layer. In this case, the high pillow portion is provided on a part covering the intermediate conductor of the intermediate resin layer.

An intermediate metal layer having conductivity higher than the metal portion may be provided between the metal portion and the base insulating layer. In this case, the low pillow portion may be provided on a part not covering the intermediate metal layer of the base insulating layer, and the high pillow portion is provided on a part covering the intermediate metal layer of the base insulating layer.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view of part of a suspension comprising a slider mounting portion according to the first embodiment.

FIG. 2 is a plan view of a flexure of the suspension shown in FIG. 1 as viewed from a side opposite to FIG. 1.

FIG. 3 is a schematic cross-sectional view of the slider mounting portion along the F3–F3 line of FIG. 2.

FIG. 4 is a cross-sectional view schematically showing an example of a disk drive.

FIG. 5 is a schematic cross-sectional view of a slider mounting portion according to the second embodiment.

FIG. 6 is a schematic cross-sectional view of a slider mounting portion according to the third embodiment.

FIG. 7 is a schematic cross-sectional view of a slider mounting portion according to the fourth embodiment.

FIG. 8 is a schematic cross-sectional view of a slider mounting portion according to the fifth embodiment.

FIG. 9 is a schematic cross-sectional view of a slider mounting portion according to the sixth embodiment.

FIG. 10 is a schematic cross-sectional view of part of a slider mounting portion according to the seventh embodiment.

FIG. 11 is a schematic cross-sectional view of part of a slider mounting portion according to the eighth embodiment.

FIG. 12 is a schematic cross-sectional view of part of a slider mounting portion according to the ninth embodiment.

FIG. 13 is a schematic cross-sectional view of part of a slider mounting portion according to the tenth embodiment.

FIG. 14 is a schematic cross-sectional view of part of a slider mounting portion according to the eleventh embodiment.

FIG. 15 is a schematic cross-sectional view of part of a slider mounting portion according to the twelfth embodiment.

### DETAILED DESCRIPTION OF THE INVENTION

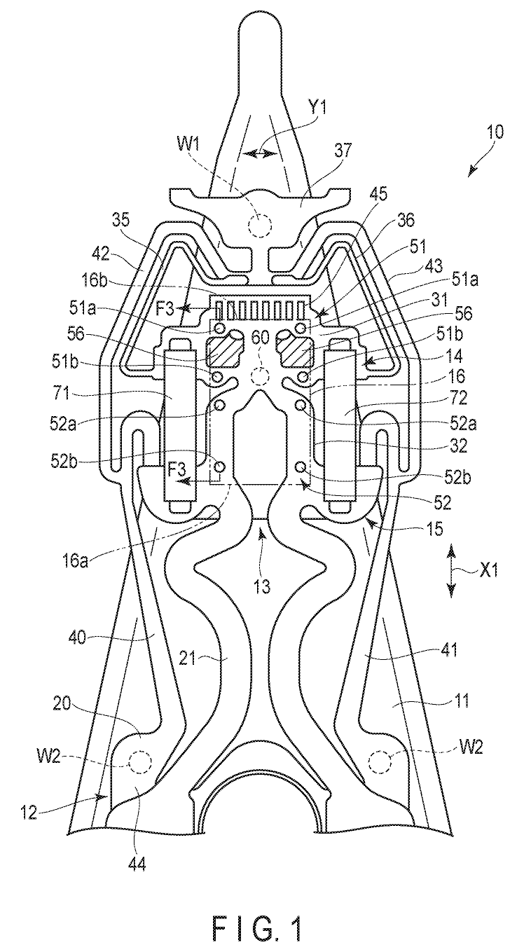

### First Embodiment FIG. 1 to FIG. 4

The following will describe a disk drive suspension according to the first embodiment of the present invention with reference to FIG. 1 to FIG. 4. Hereinafter, the disk drive suspension is referred to as a suspension 10.

FIG. 1 is a plan view showing part of the suspension 10. The suspension 10 includes a load beam 11, a flexure 12 provided along the load beam 11, an actuator portion 14 provided on a gimbal portion 13 of the flexure 12, and a slider mounting portion 15.

A slider 16, which is a magnetic head, is mounted on the slider mounting portion 15. The slider 16 includes a leading-side portion 16a and a trailing-side portion 16b. In this specification, "the leading side" is a side on which air flows into space between the slider 16 and the disk when the disk rotates, and "the trailing side" is a side on which air flows out. A plurality of elements capable of converting a magnetic signal and an electric signal, for example MR elements, are provided at an end of the trailing-side portion 16b. These elements perform access such as writing or reading of data with respect to the disk.

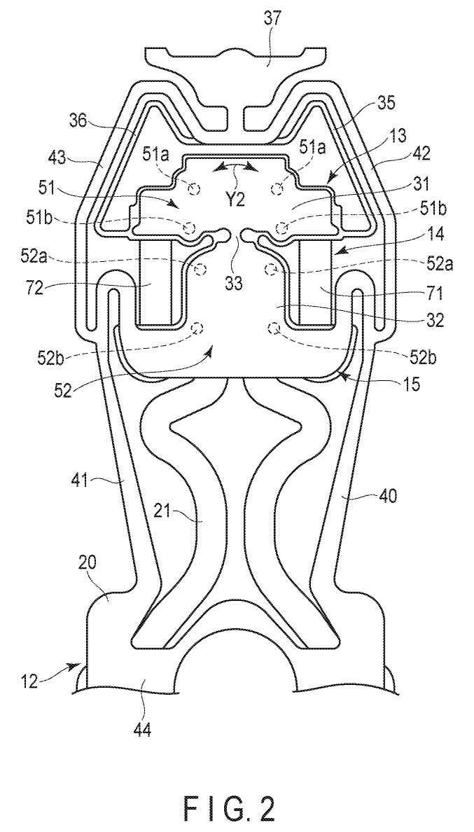

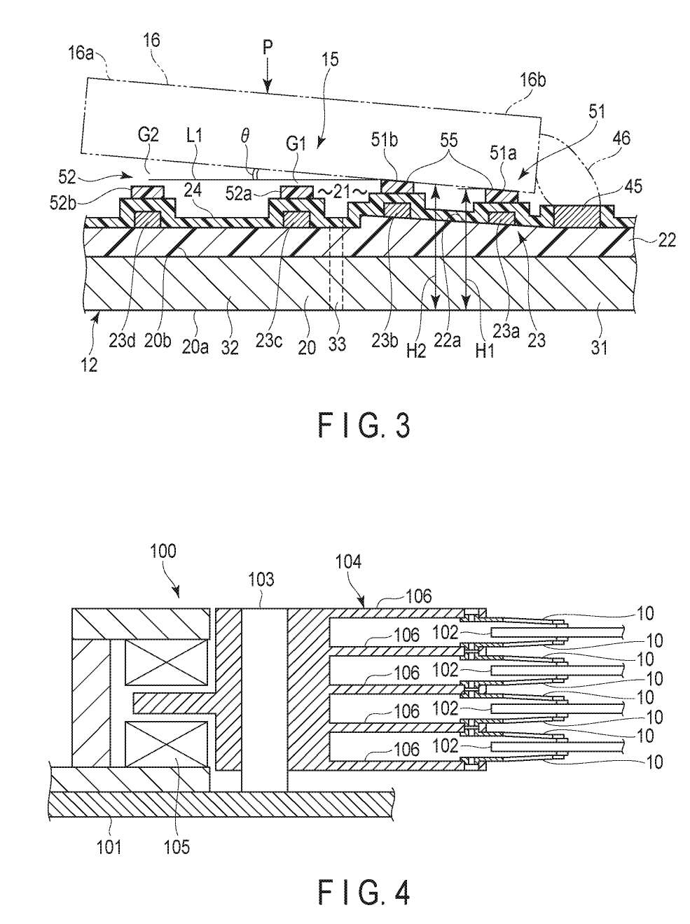

FIG. 2 is a plan view of the flexure 12 as viewed from a side opposite to FIG. 1. FIG. 3 is a schematic cross-sectional view of the flexure 12 along the F3–F3 line of FIG. 2.

The load beam 11 is formed of, for example, a stainless-steel plate and extends in a longitudinal direction of the suspension 10. The thickness of the load beam 11 is, for example, 20 to 40 μm, but is not limited to this example. The direction indicated by a double-headed arrow X1 in FIG. 1 is the longitudinal direction of the load beam 11, that is, the longitudinal direction of the flexure 12 (the longitudinal direction of the suspension 10). A double-headed arrow Y1 in FIG. 1 indicates the sway direction, that is, the width direction of the distal end portion of the flexure 12.

The flexure 12 includes a metal portion 20 formed of a thin metal plate such as stainless steel and a circuit portion 21 provided along the metal portion 20. The metal portion 20 is a base of the flexure 12. The thickness of the metal portion 20 is, for example, 20 μm (12 to 25 μm), but the thickness is not limited to this example. The thickness of the metal portion 20 is smaller than the thickness of the load beam 11. As shown in FIG. 1, the metal portion 20 is fixed to the load beam 11 by a first weld portion W1 and second weld portions W2.

As shown in FIG. 3, the slider mounting portion 15 includes the metal portion 20, a base insulating layer 22, an embedded portion 23 including a plurality of embedded members 23a, 23b, 23c, and 23d, and a cover resin layer 24 covering the embedded portion 23. The embedded portion 23 is provided on the base insulating layer 22. The metal portion 20 has a first surface 20a and a second surface 20b on a side opposite to the first surface 20a.

The first surface 20a of the metal portion 20 is synonymous with "the surface of the flexure" in this specification. The base insulating layer 22 overlaps the second surface 20b. The embedded members 23a, 23b, 23c, and 23d are formed of, for example, conductive materials. Alternatively, the embedded members 23a, 23b, 23c, and 23d may be resins such as polyimides. The base insulating layer 22 and the cover resin layer 24 are formed of electrically insulating resins such as polyimides.

The slider mounting portion 15 is formed on a part of the flexure 12. In this field, the slider mounting portion 15 is sometimes referred to as a tongue. The slider 16 is mounted on the slider mounting portion 15. The slider mounting portion 15 is part of the gimbal portion 13. As shown in FIG. 2, the slider mounting portion 15 includes, in the longitudinal direction of the flexure 12, a first portion 31, a second portion 32, and a connecting portion 33.

The first portion 31, the second portion 32, and the connecting portion 33 are each part of the metal portion 20. For example, etching forms outlines of the first portion 31, the second portion 32, and the connecting portion 33. The first portion 31 and the second portion 32 are connected to each other by the connecting portion 33. The width of the connecting portion 33 is sufficiently smaller than the widths of the first portion 31 and the second portion 32. The first portion 31 is movable relative to the second portion 32 in the sway direction (the direction indicated by the double-headed arrow Y1 in FIG. 1).

The first portion 31 is supported at a distal end portion 37 of the flexure 12 by connecting members 35 and 36. The connecting members 35 and 36 are formed of resins such as polyimides and have flexibility. The second portion 32 is supported at a main body portion 44 of the flexure 12 via arm portions 40, 41, 42, and 43 which are each constituted by part of the metal portion 20. A terminal portion 45 (shown in FIG. 1 and FIG. 3) is provided on the first portion 31. The terminal portion 45 is electrically connected to the element of the slider 16 via a conductive member 46.

A first pillow structure 51 is provided on the first portion 31. The first pillow structure 51 includes a low pillow portion 51a having a first height H1 and a high pillow portion 51b having a second height H2. The first height H1 and the second height H2 are heights from the metal portion 20, that is, heights from the surface 20a of the flexure 12. Increasing the thickness of the base insulating layer 22 in a tapered manner from the low pillow portion 51a toward the high pillow portion 51b forms a resin taper portion 22a whose thickness changes.

The low pillow portion 51a having the first height H1 is provided on the smaller-thickness side of the resin taper portion 22a. The high pillow portion 51b having the second height H2 is provided on the larger-thickness side of the resin taper portion 22a. In the example shown in FIG. 3, the embedded members 23a and 23b are provided respectively in the low pillow portion 51a and the high pillow portion 51b. Embedded members may not be provided in pillow portions 52a and 52b.

A second pillow structure 52 is provided on the second portion 32. The second pillow structure 52 has one or more pillow portions 52a and 52b. The pillow portions 52a and 52b are formed of, for example, the same resin as the cover resin layer 24 and have convex shapes toward the slider 16. Heights of the pillow portions 52a and 52b may be equal to each other or may be different from each other. In the example shown in FIG. 3, the embedded members 23c and 23d are provided respectively in the pillow portions 52a and 52b. Embedded members may not be provided in the pillow portions 52a and 52b.

As shown in FIG. 3, a slider support surface 55 is inclined at an angle θ with respect to a virtual line segment L1 parallel to the surface 20a of the flexure 12. The angle θ is, for example, a small value not more than 1°, but is drawn at an exaggerated angle in FIG. 3 for ease of understanding. In a state where the slider 16 is supported on the slider support surface 55, gaps G1 and G2 are formed between the slider 16 and the second pillow structure 52. The gaps G1 and G2 are, for example, small values of not more than 0.1 μm, but are drawn with an exaggerated size in FIG. 3 for ease of understanding.

As shown in FIG. 1, the slider 16 is mounted on the slider mounting portion 15. Before the slider 16 is mounted, an adhesive 56 (indicated by hatching in FIG. 1) is supplied to the first portion 31. The adhesive 56 fixes the trailing-side portion 16b of the slider 16 to the first portion 31. The adhesive 56 is not supplied to the second portion 32. Thus, the leading-side portion 16a of the slider 16 is movable relative to the second portion 32 in a direction along the surface 20a of the flexure (in-plane direction).

The uncured adhesive 56 is supplied to the first portion 31, and the adhesive 56 cures in a state where a load P (shown in FIG. 3) is applied to the slider 16 in the thickness direction of the slider 16. When the load P is applied, the slider mounting portion 15 is pressed in a direction in which the gaps G1 and G2 become zero. Thus, the slider 16 is supported at a predetermined position by the first pillow structure 51 and the second pillow structure 52. The adhesive 56 cures in this state. Thus, the slider 16 can be bonded to the predetermined position. Removing the load P after the curing of the adhesive 56 allows the gaps G1 and G2 to substantially recover.

As shown in FIG. 1, a dimple portion 60 is formed in the load beam 11. The dimple portion 60 has a protrusion that projects toward the slider mounting portion 15. The protrusion of the dimple portion 60 contacts the connecting portion 33 of the slider mounting portion 15, swingably supporting the slider mounting portion 15.

The actuator portion 14 includes a pair of actuator elements 71 and 72. The actuator elements 71 and 72 are provided on both sides of the slider 16. Each of the actuator elements 71 and 72 is formed of a piezoelectric material such as PZT, for example, and move the first portion 31 by a minute amount in the sway direction in accordance with an applied voltage.

FIG. 4 is a schematic cross-sectional view of an example of a hard disk drive (HDD) 100. The hard disk drive 100 includes a case 101 (partially shown), a disk 102 which rotates about a spindle, a carriage 104 pivotable about a pivot shaft 103, and a positioning motor 105. The motor 105 drives the carriage 104. The casing 101 is sealed by a lid. The suspension 10 is mounted on a distal end of an arm portion 106 of the carriage 104.

The motor 105 for positioning causes the carriage 104 to pivot, moving the suspension 10 in a radial direction of the disk 102. This moves the slider 16 to a target position of the disk 102. Rotation of the disk 102 makes air flow between the slider 16 and the disk 102, forming an air bearing.

Voltage applied to the actuator elements 71 and 72 distorts the actuator elements 71 and 72 in opposite directions according to the voltage level. Thus, as shown by the double-headed arrow Y2 in FIG. 2, the first portion 31 moves relative to the second portion 32 via the connecting portion 33. The first portion 31 moving relative to the second portion 32 in the direction indicated by the arrow Y2 moves an end portion of the trailing-side portion 16b of the slider 16, that is, a part where the element for reading and writing is provided, in the sway direction (indicated by the double-headed arrow Y1 in FIG. 1). At that time, the leading-side portion 16a moves relative to the second pillow structure 52 in a direction along the surface 20a of the flexure.

If the slider 16 is in contact with the second pillow structure 52, friction between the slider 16 and the second pillow structure 52 at the time of movement of the slider 16 influences the stroke of the slider 16. The slider 16 contacting and separating from the second pillow structure 52 makes the stroke of the slider 16 unstable, which is undesirable.

The suspension 10 of the present embodiment can maintain the gaps G1 and G2 (shown in FIG. 3) between the slider 16 and the second pillow structure 52. Therefore, even when the leading-side portion 16a of the slider 16 moves relative to the second pillow structure 52, friction between the slider 16 and the second pillow structure 52 can be avoided. Thus, the slider 16 can move with stable stroke characteristics.

The first portion 31 moving relative to the second portion 32 in the direction along the surface 20a of the flexure moves the leading-side portion 16a of the slider 16 relative to the second pillow structure 52 in the direction along the surface 20a of flexure. Among the pillow portions 52a and 52b of the second pillow structure 52, the pillow portion 52b farther from the connecting portion 33 has a larger amount of relative movement with respect to the slider 16 than the pillow portion 52a closer to the connecting portion 33.

The metal portion 20 of the slider mounting portion 15 is substantially flat. Microscopically, the second portion 32 may be slightly curved in a thickness direction. In that case, the gaps G1 and G2 between the slider 16 and the second pillow structure 52 potentially approach zero. The pillow portion 52b farther from the connecting portion 33 has a larger relative movement with respect to the slider 16 than the pillow portion 52a closer to the connecting portion 33. Thus, contact between the pillow portion 52b and the slider 16 is undesirable.

As shown in FIG. 3, in the slider mounting portion 15 of the present embodiment, the slider support surface 55 of the first pillow structure 51 supports the slider 16 at the angle θ. That is, the slider support surface 55 is inclined at the angle θ in a direction in which the gap G2 is maintained between the slider 16 and the pillow portion 52b. Therefore, the slider mounting portion 15 of the preset embodiment has a preferable support manner for avoiding contact between the slider 16 and the pillow portion 52b.

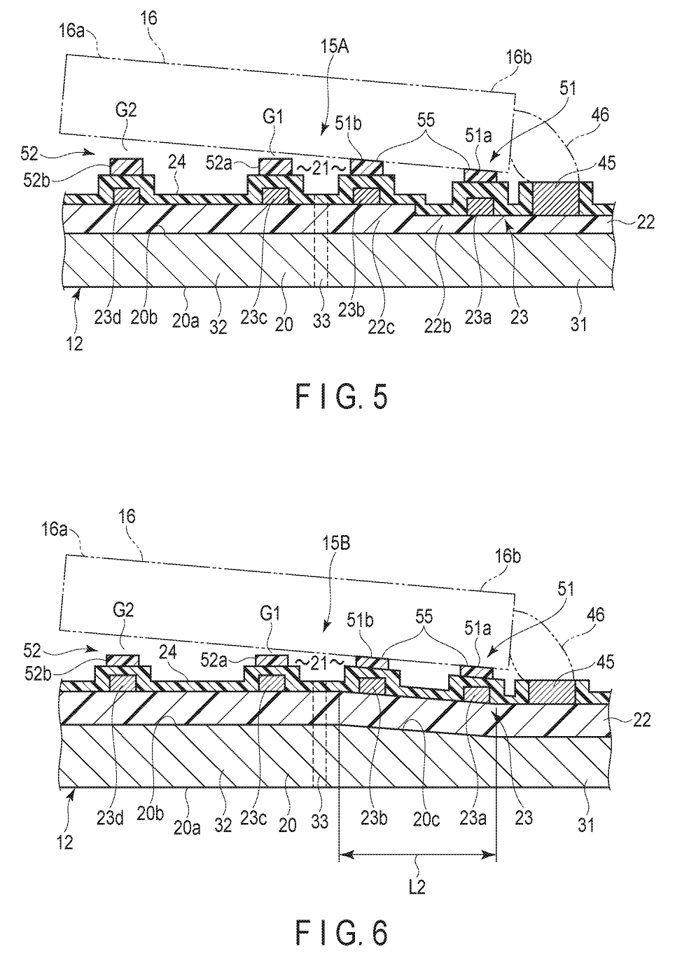

### Second Embodiment FIG. 5

FIG. 5 is a schematic cross-sectional view of a slider mounting portion 15A according to the second embodiment. In the slider mounting portion 15A, a first base portion 22b having a small thickness and a second base portion 22c having a large thickness are formed in the base insulating layer 22. The low pillow portion 51a is provided on the first base portion 22b, and the high pillow portion 51b is provided on the second base portion 22c. The other configurations effects of the slider mounting portion 15A are the same as those of the slider mounting portion 15 of the first embodiment. Thus, explanations of these overlapping constituent elements are omitted by adding common reference numbers thereto.

### Third Embodiment FIG. 6

FIG. 6 is a schematic cross-sectional view of a slider mounting portion 15B according to the third embodiment. In the slider mounting portion 15B, a metal taper portion 20c whose thickness changes over a length L2 is formed in the metal portion 20. The low pillow portion 51a is provided on the smaller-thickness side of the metal taper portion 20c, and the high pillow portion 51b is provided on the larger-thickness side. The other configurations effects of the slider mounting portion 15B are the same as those of the slider mounting portion 15 of the first embodiment. Thus, explanations of these overlapping constituent elements are omitted by adding common reference numbers thereto.

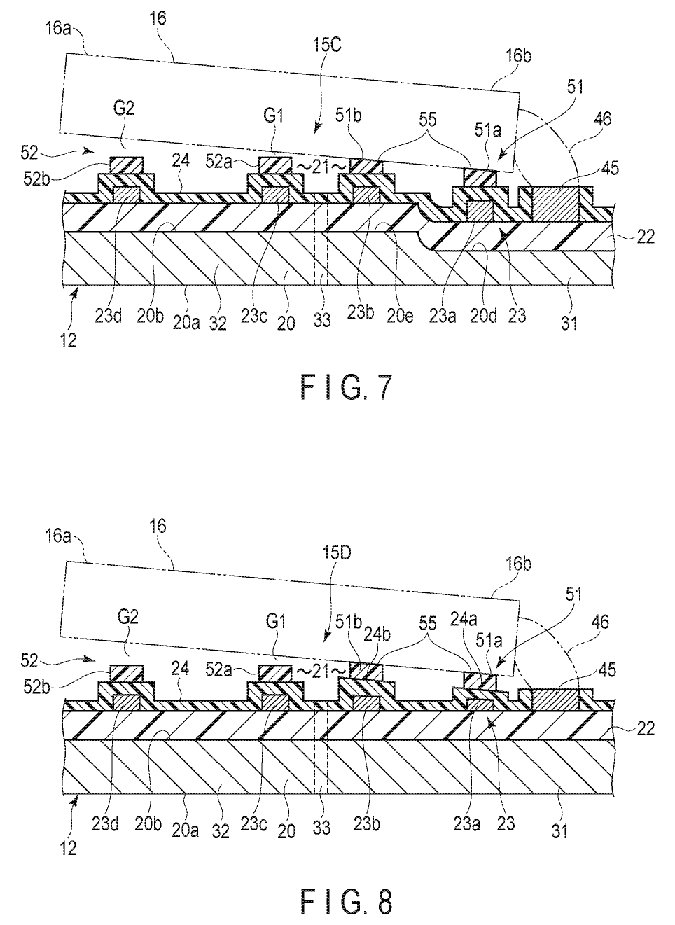

### Fourth Embodiment FIG. 7

FIG. 7 is a schematic cross-sectional view of a slider mounting portion 15C according to the fourth embodiment. In the slider mounting portion 15C, a first metal portion 20d having a small thickness is formed on the metal portion 20, for example, by etching. The low pillow portion 51a is provided on the first metal portion 20d. The high pillow portion 51b is provided on a second metal portion 20e having a large thickness. The other configurations effects of the slider mounting portion 15C are the same as those of the slider mounting portion 15 of the first embodiment. Thus, explanations of these overlapping constituent elements are omitted by adding common reference numbers thereto.

### Fifth Embodiment FIG. 8

FIG. 8 is a schematic cross-sectional view of a slider mounting portion 15D according to the fifth embodiment. In the slider mounting portion 15D, the cover resin layer 24 has a first inclined portion 24a having a small thickness formed at a position corresponding to the low pillow portion 51a and a second inclined portion 24b having a large thickness formed at a position corresponding to the high pillow portion 51b. The low pillow portion 51a is provided on the first inclined portion 24a, and the high pillow portion 51b is provided on the second inclined portion 24b. The other configurations effects of the slider mounting portion 15D are the same as those of the slider mounting portion 15 of the first embodiment. Thus, explanations of these overlapping constituent elements are omitted by adding common reference numbers thereto.

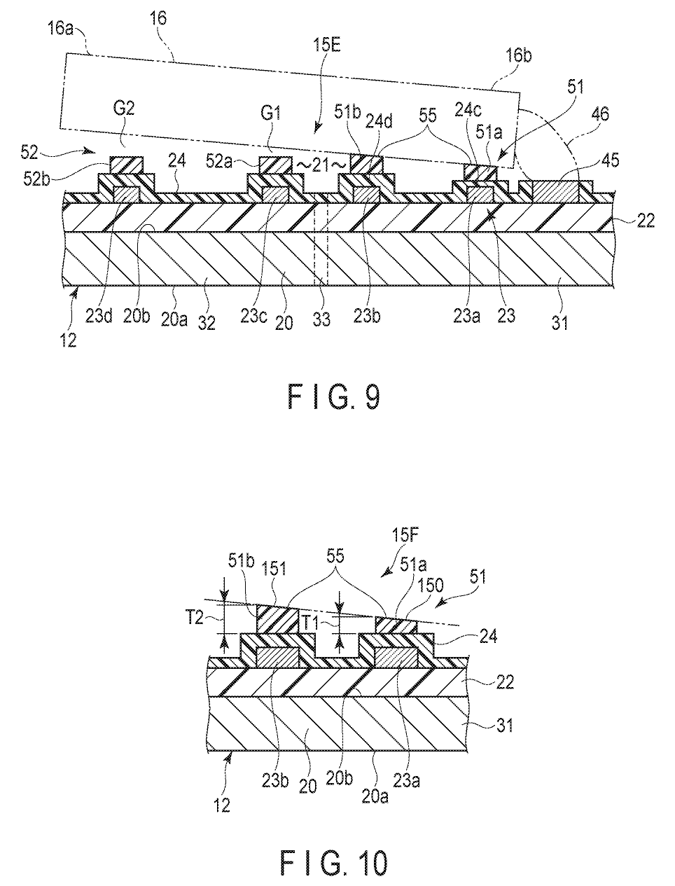

### Sixth Embodiment FIG. 9

FIG. 9 is a schematic cross-sectional view of a slider mounting portion 15E according to the sixth embodiment. In the slider mounting portion 15E, the cover resin layer 24 has a first cover portion 24c having a small thickness provided on the first portion 31 and a second cover portion 24d having a thickness greater than the first cover portion 24c. The low pillow portion 51a is provided on the first cover portion 24c, and the high pillow portion 51b is provided on the second cover portion 24d. The low pillow portion 51a and the high pillow portion 51b each have an end surface inclined along the slider support surface 55. The other configurations effects of the slider mounting portion 15E are the same as those of the slider mounting portion 15 of the first embodiment. Thus, explanations of these overlapping constituent elements are omitted by adding common reference numbers thereto.

### Seventh Embodiment FIG. 10

FIG. 10 is a schematic cross-sectional view of part of a slider mounting portion 15F according to the seventh embodiment. The slider mounting portion 15F has the low pillow portion 51a of having small thickness T1 and the high pillow portion 51b having a large thickness T2. An end surface (a first end surface 150) of the low pillow portion 51a and an end surface (a second end surface 151) of the high pillow portion 51b are inclined in a tapered manner. The slider support surface 55 is defined by the inclined first end surface 150 and the inclined second end surface 151. The other configurations effects of the slider mounting portion 15F are the same as those of the slider mounting portion 15 of the first embodiment. Thus, explanations of these overlapping constituent elements are omitted by adding common reference numbers thereto.

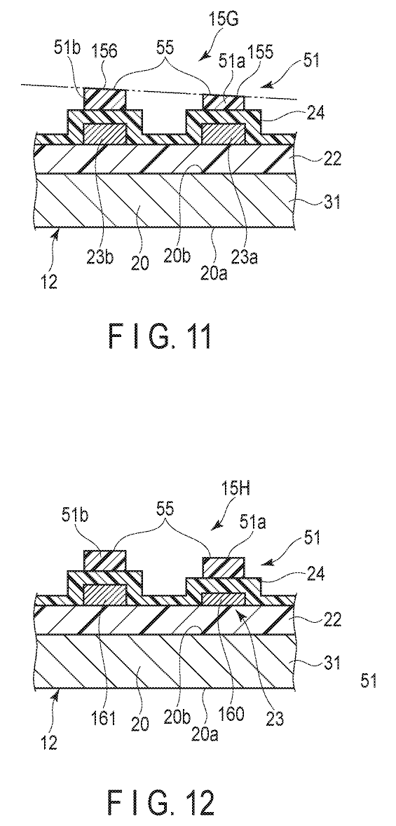

### Eighth Embodiment FIG. 11

FIG. 11 is a schematic cross-sectional view of part of a slider mounting portion 15G according to the eighth embodiment. The slider mounting portion 15G has the low pillow portion 51a having a small thickness and the high pillow portion 51b having a thickness greater than the low pillow portion 51a. An end surface (a first end surface 155) of the low pillow portion 51a and an end surface (a second end surface 156) of the high pillow portion 51b are each substantially parallel to the surface 20a of the flexure 12. The slider support surface 55 is defined by the first end surface 155 and the second end surface 156 having a height difference. The other configurations effects of the slider mounting portion 15G are the same as those of the slider mounting portion 15 of the first embodiment. Thus, explanations of these overlapping constituent elements are omitted by adding common reference numbers thereto.

### Ninth Embodiment FIG. 12

FIG. 12 is a schematic cross-sectional view of part of a slider mounting portion 15H according to the ninth embodiment. The slider mounting portion 15H has a first embedded member 160 and a second embedded member 161 having a thickness greater than the first embedded member 160. The low pillow portion 51a is provided on a part covering the first embedded member 160 of the cover resin layer 24. The high pillow portion 51b is provided on a part covering the second embedded member 161 of the cover resin layer 24. The other configurations effects of the slider mounting portion 15H are the same as those of the slider mounting portion 15 of the first embodiment. Thus, explanations of these overlapping constituent elements are omitted by adding common reference numbers thereto.

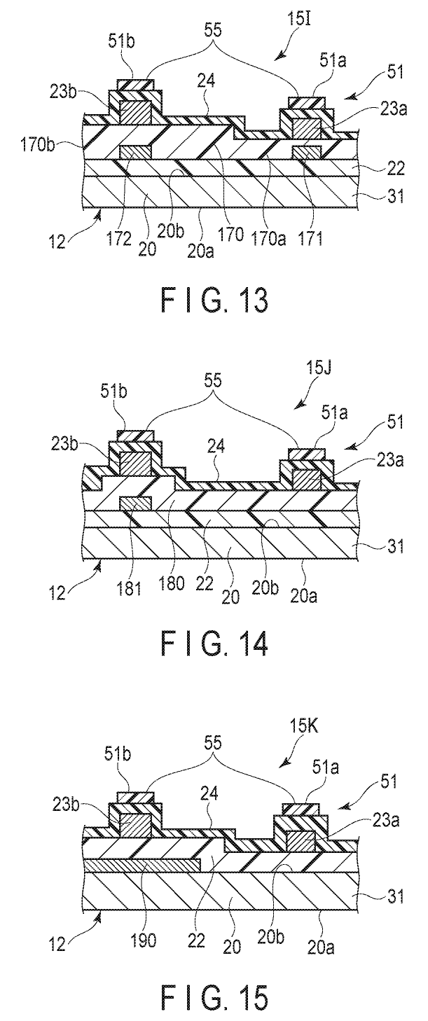

### Tenth Embodiment FIG. 13

FIG. 13 is a schematic cross-sectional view of part of a slider mounting portion 15I according to the tenth embodiment. The slider mounting portion 15I has an intermediate resin layer 170, a first intermediate conductor 171, and a second intermediate conductor 172. The intermediate resin layer 170 is formed between the base insulating layer 22 and the cover resin layer 24. The intermediate resin layer 170 includes a first resin portion 170a having a small thickness and a second resin portion 170b having a thickness greater than the first resin portion 170a.

The low pillow portion 51a is provided on the first resin portion 170a. The high pillow portion 51b is provided on the second resin portion 170b. The other configurations effects of the slider mounting portion 15I are the same as those of the slider mounting portion 15 of the first embodiment. Thus, explanations of these overlapping constituent elements are omitted by adding common reference numbers thereto.

### Eleventh Embodiment FIG. 14

FIG. 14 is a schematic cross-sectional view of part of a slider mounting portion 15J according to the eleventh embodiment. In the slider mounting portion 15J, an intermediate resin layer 180 and an intermediate conductor 181 are provided between the base insulating layer 22 and the cover resin layer 24. Providing the high pillow portion 51b in a part covering the intermediate conductor 181 of the

intermediate resin layer 180 forms a height difference between the low pillow portion 51a and the high pillow portion 51b. The other configurations effects of the slider mounting portion 15J are the same as those of the slider mounting portion 15 of the first embodiment. Thus, explanations of these overlapping constituent elements are omitted by adding common reference numbers thereto.

### Twelfth Embodiment FIG. 15

FIG. 15 is a schematic cross-sectional view of part of a slider mounting portion 15K according to the twelfth embodiment. In the slider mounting portion 15K, an intermediate metal layer 190 is provided between the metal portion 20 and the base insulating layer 22. The intermediate metal layer 190 is formed of a metal having conductivity higher than stainless steel (for example, copper), which is the material of the metal portion 20. The low pillow portion 51a is provided on a part not covering the intermediate metal layer 190 of the base insulating layer 22. The high pillow portion 51b is provided on a part covering the intermediate metal layer 190 of the base insulating layer 22. The other configurations effects of the slider mounting portion 15K are the same as those of the slider mounting portion 15 of the first embodiment. Thus, explanations of these overlapping constituent elements are omitted by adding common reference numbers thereto.

When the invention is carried out, it goes without saying that, within the scope of the invention, various modifications can be made, for example to the configuration and positions of the low pillow portion and the high pillow portion of the first pillow structure, the pillow portions of the second pillow structure, and the individual components constituting the flexure including the slider mounting portion.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A flexure for a disk drive suspension having a slider mounting portion on which a slider is mounted, wherein
the slider mounting portion includes:
a first portion to which the slider is fixed;
a second portion in which the slider is movable;
a connecting portion connecting the first portion and the second portion to each other;
a first pillow structure provided on the first portion and having a convex shape protruding toward the slider; and
a second pillow structure provided on the second portion and having a convex shape protruding toward the slider, and
the first pillow structure, comprises:
a low pillow portion having a first height with respect to a surface of the flexure;
a high pillow portion located closer to the second portion than the low pillow portion and having a second height greater than a height of the low pillow portion; and
a slider support surface defined by the low pillow portion and the high pillow portion and defining a gap between the slider and the second pillow structure while supporting the slider.

2. The flexure of claim 1, wherein
the slider mounting portion includes:
a metal portion;
a base insulating layer along the metal portion;
an embedded portion along the base insulating layer;
a cover resin layer covering the embedded portion; and
the first pillow structure and the second pillow structure are provided on the cover resin layer.

3. The flexure of claim 1, wherein
when the flexure is viewed from a side in a longitudinal direction of the disk drive suspension, the slider support surface is inclined at an angle with respect to a virtual line segment along the surface of the flexure in a direction in which the slider separates from the second pillow structure.

4. The flexure of claim 2, wherein
the base insulating layer has a resin taper portion whose thickness changes,
the low pillow portion is provided on a smaller-thickness side of the resin taper portion, and
the high pillow portion is provided on a larger-thickness side of the resin taper portion.

5. The flexure of claim 2, wherein
the base insulating layer comprises:
a first base portion having a small thickness; and
a second base portion having a thickness greater than the first base portion,
the low pillow portion is provided on the first base portion, and
the high pillow portion is provided on the second base portion.

6. The flexure of claim 2, wherein
the metal portion comprises:
a metal taper portion whose thickness changes from a smaller-thickness side to a larger-thickness side, wherein
the low pillow portion is provided on the smaller-thickness side of the metal taper portion, and
the high pillow portion is provided on the larger-thickness side of the metal taper portion.

7. The flexure of claim 2, wherein
the metal portion comprises:
a first metal portion having a small thickness; and
a second metal portion having a thickness greater than the first metal portion,
the low pillow portion is provided on the first metal portion, and
the high pillow portion is provided on the second metal portion.

8. The flexure of claim 2, further comprising:
a first inclined portion having a small thickness formed in a part where the low pillow portion is provided of the cover resin layer; and
a second inclined portion having a large thickness formed in a part where the high pillow portion is provided of the cover resin layer, wherein
the slider support surface is defined by the first inclined portion and the second inclined portion.

9. The flexure of claim 2, wherein
the cover resin layer comprises:
a first cover portion having a small thickness; and
a second cover portion having a thickness greater than the first cover portion,
the low pillow portion is provided on the first cover portion, and
the high pillow portion is provided on the second cover portion.

10. The flexure of claim 2, wherein
the low pillow portion has a first end surface inclined along the slider support surface, and
the high pillow portion has a second end surface inclined along the slider support surface.

11. The flexure of claim 2, wherein
the low pillow portion having a first end surface along the surface of the flexure is provided on the cover resin layer, and
the high pillow portion having a thickness greater than the low pillow portion and having a second end surface along the surface of the flexure is provided on the cover resin layer.

12. The flexure of claim 2, wherein
the embedded portion comprises:
a first embedded member; and
a second embedded member having a thickness greater than the first embedded member,
the low pillow portion is provided on a part covering the first embedded member of the cover resin layer, and
the high pillow portion is provided on a part covering the second embedded member of the cover resin layer.

13. The flexure of claim 2, wherein
an intermediate resin layer comprising a first resin portion having a small thickness and a second resin portion having a large thickness is provided between the base insulating layer and the cover resin layer,
the low pillow portion is provided on the first resin portion, and
the high pillow portion is provided on the second resin portion.

14. The flexure of claim 2, wherein
an intermediate resin layer and an intermediate conductor are provided between the base insulating layer and the cover resin layer, and
the high pillow portion is provided on a part covering the intermediate conductor of the intermediate resin layer.

15. The flexure of claim 2, further comprising:
an intermediate metal layer having conductivity higher than the metal portion and provided between the metal portion and the base insulating layer, wherein
the low pillow portion is provided on a part not covering the intermediate metal layer of the base insulating layer, and
the high pillow portion is provided on a part covering the intermediate metal layer of the base insulating layer.
